(19) United States
(12) Patent Application Publication
(10) Pub. No.: US 2022/0051345 A1
(43) Pub. Date: Feb. 17, 2022

(54) FLAG SYSTEM AND METHOD OF FLAGGING FOR REAL-TIME EXPENDITURES TRANSACTED ELECTRONICALLY

(71) Applicant: Peter Garrett, San Francisco, CA (US)

(72) Inventor: Peter Garrett, San Francisco, CA (US)

(21) Appl. No.: 16/991,934

(22) Filed: Aug. 12, 2020

(51) Int. Cl. G06Q 40/00; G06Q 20/20; G06Q 20/32; G06Q 30/04; G06Q 20/10; G06Q 20/36; G06Q 20/22; G06Q 20/34; G06F 3/0482

(52) U.S. Cl. CPC G06Q 40/10; G06Q 20/207; G06Q 20/209; G06Q 20/326; G06Q 30/04; G06Q 20/108; H04L 67/10; G06Q 20/227; G06Q 20/3276; G06Q 40/12; G06Q 20/341; G06Q 20/204; G06F 3/0482; G06Q 20/367

(57) ABSTRACT

A method is provided for flagging an electronic transaction amount or a portion thereof as a potential tax deductible expense the method including receiving or otherwise acquiring an electronic transaction record at a mobile computing device, the computing device having network-access capability and connected to the communications network, the record displayed in a dedicated payment application executed on the computing device, assigning or otherwise confirming through a dedicated payment application on the computing device to a connected network server a payment account to debit to pay the transaction amount or portion thereof electronically, and inputting a response to an interactive prompt, pop up, or notification appearing in the dedicated payment application the input response requesting the network server to flag the transaction amount or portion thereof as a potential tax deductible expense.

### CROSS-REFERENCE TO RELATED DOCUMENTS

[NA]

### BACKGROUND OF THE INVENTION

### 1. Field of the Invention

The present invention is in the field of electronic calculation, identification of transactions, and pertains particularly to methods and apparatus for marking or flagging expenditures for tax deduct-ability in real time as a mobile transaction device is used to perform a transaction.

### 2. Discussion of the State of the Art

Payment cards are part of a payment system used by financial institutions like banks, for example, to enable cardholders to access funds held in designated bank accounts or credit accounts. The cardholder may make payments by electronic funds transfer (EFT) and access automated teller machines (ATM's). There are several types of payment cards in the art, perhaps the most common classes being credit cards and debit cards.

A more recent type of payment card existing in the art is generally termed a smart card in the art. Smart cards are payment cards that contain a unique card number and some security information such as an expiration date or card verification value (CVV) and a magnetic strip and an embedded euro-pay master card and visa (EMV) chip (secure element) enabling various machines (transaction point terminals) to read and access information from the card.

More recently, smart cards have been adapted as mobile dynamic smart transaction cards. A dynamic smart card may have multiple payment card data sets dynamically accessed or loaded onto the single form factor of the card. A user may add any or all payment card data from debit, credit, and loyalty accounts to a mobile application associated (cloud wallet) with the smart card. The user may load the data onto the smart card via Bluetooth or any wireless technology.

All-in-one smart cards are referred to in the field as dynamic smart cards. An owner of a dynamic smart card may load multiple payment account data sets onto a single payment card form factor or associated cloud wallet. A user may add payment card data sets for debit, credit, gift, and loyalty to the dynamic smart card. For example, the user may leverage a mobile phone application (executed on phone) associated with the dynamic smart card to authenticate (identity, confirm) and access or move the payment card data sets onto the dynamic smart card over a Bluetooth™ wireless network connection between the user's smart cloud wallet application to the users smartphone and the dynamic smart card.

One important aspect of expenditure is whether the expenditure or part of the expenditure may be a tax deduction. In general practice some applications like bank card applications tied to banks may enable a user working in the application to browse expenditure items by category and item specifics for assigning items as tax deductable expenditures made by the user. However, the user must navigate much data to find entries for marking as tax deductible entries. Moreover, such institutions are not required or set up to record any additional information other than the expense and the payee. With more complex payment services including dynamic smart cards to which any wallet cloud stored card may be represented it may be desired that potential tax deductible expenditures might be marked and categorized in real time just before or just after a card purchase is made.

Therefore, what is clearly needed is a method for flagging electronic expenditures as potential tax-deductible expenditures just before a transaction, at the time of a transaction or after the time of a transaction to satisfy the flagging of an electronic transaction according to one embodiment of the invention.

### BRIEF SUMMARY OF THE INVENTION

According to an embodiment of the present invention, a method for electronic flagging an electronic transaction amount or a portion thereof as a potential tax ramifications or as a deductible expense is provided wherein the transaction is initiated at a point of sale (POS) terminal or interface connected to a communications network, the method including steps for (a) receiving or otherwise acquiring an electronic transaction record at a mobile computing device, the computing device having network-access capability and connected to the communications network, the record generated at the POS terminal or interface, the record displayed in a dedicated payment application executed on the computing device, (b) assigning or otherwise confirming through the dedicated payment application connected to a network server a payment from an account to pay the transaction amount or portion thereof electronically, and (c) inputting a response to an interactive prompt, an interactive pop up, or interactive notification presented in or appearing in the dedicated payment application from the network server of (b) asking if the record should be flagged as a potential tax deductible expense, the input response requesting the network server of (b) to flag the transaction amount, identification information and/or a portion thereof as a potential tax deductible expense.

In one aspect of the method, the communications network includes the Internet network and any connected access networks. In one aspect, in step (a) the computing device is a mobile hand-held telephone and the payment application is a client application of a cloud-based wallet account managed through the network server storing authorized payment data including account or card number and account type for more than one payment account including the tax ID number. In a preferred aspect of the method, in step (a) the transaction record includes a transaction date, tax ID number, a transaction time, a merchant identification, a POS location, and a transaction number and wherein the transaction record is transmitted wirelessly or by carrier network from the POS to the mobile computing device.

In one aspect of the method, in step (a) the transaction record includes a transaction date, a transaction time, tax ID number, a merchant identification, a POS location, and transaction number and wherein the transaction record is printed and scanned into the mobile communications device using an optical scanning feature. In one aspect in step (b) the payment accounts are presented in a list for selection via selection boxes or interactive icons. In one aspect, in step (c) the method of input is touch screen selection, response to a notification message, or a voice confirmation of yes or no.

In one aspect of the method, in step (c) a further sub step is provided for assigning a tax category for the flagged transaction amount or portion thereof. In one aspect of the method a step (d) is included for recording the flagged electronic transaction record in a data repository coupled to the network server of (b) under records for the account selected to pay the transaction amount or portion thereof. In one aspect, in step (b) the transaction amount or portion thereof is paid electronically using a transaction card having a rewrite-able memory thereon. In another aspect, in step (b) the transaction amount or portion thereof is paid electronically using a wireless transaction device in the form of a watch or a ring or any other wearable payment enabled device. In one aspect of the method in step (b) the transaction amount or portion thereof is paid electronically using the mobile hand-held telephone having a cloud wallet capability.

### BRIEF DESCRIPTION OF THE SEVERAL VIEWS OF THE DRAWINGS

FIG. 1 is an architectural view of a communication system supporting transaction flagging according to an embodiment of the present invention.

FIG. 2 is a screen shot of a mobile application interface supporting a dynamic transaction at a point of sale terminal (POS).

FIG. 3 is a screen shot of the mobile application interface of FIG. 2 adapted for displaying paying an itemized bill.

FIG. 4 is a sequence diagram depicting a tax deduct-ability flagging sequence according to one embodiment of the invention.

FIG. 5 is a sequence diagram depicting interaction between nodes handling a transaction, transaction flagging, and archiving.

FIG. 6 is a process flow chart depicting steps for applying a tax deduction status to an expenditure transacted at a POS terminal.

### DETAILED DESCRIPTION OF THE INVENTION

In various embodiments described in enabling detail herein, the inventor provides a unique system and method for electronic flagging of transaction records as potential tax-deductible expenses. The present invention is described using the following examples, which may describe more than one relevant embodiment falling within the scope of the invention.

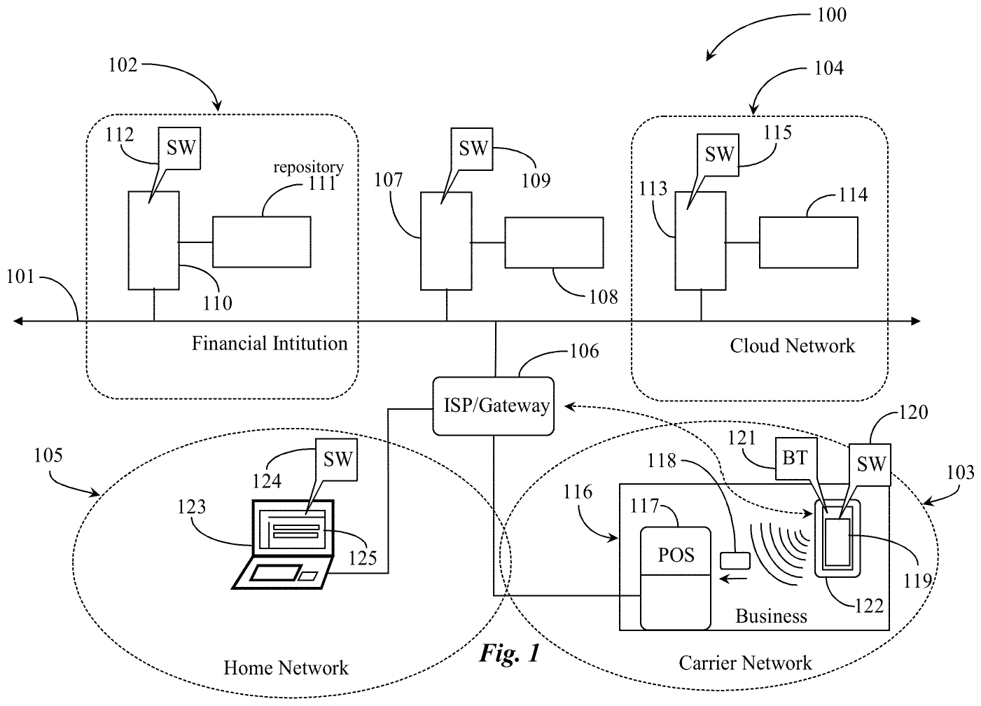

FIG. 1 is an architectural view of a communications network 100 supporting transaction flagging according to an embodiment of the present invention. Communications network 100 includes network backbone 101. Network backbone 101 may represent all lines, equipment, and access points routers and gateways that make up the network as a whole including connected sub networks. Communications network 100 may be an Internet network or another wide-area-network (WAN) without departing from the spirit and scope of the present invention. There are no geographic limits to the practice of the invention.

Backbone 101 supports a network cloud labeled cloud network 104. Cloud network 104 may be adapted by a financial mobile wallet service to store credit card data, debit card data, and other electronic card or account data, for a mobile user, represented herein as user phone 122 having a dynamic transaction card 118 that may be programed with a selected set of card transaction data (or as a proxy card for other data sets), for example, to make a specific transaction. Cloud network includes a server 113 supported by back bone 101 running a software (SW) application 115 and coupled to a data repository 114. SW 115 may be a cloud wallet application for a dynamic transaction device like card 118 or another device, ring or wearable used to interact with a POS sale terminal. Data repository 114 may include user identification and profile data; user accounts data, financial history data including transaction history, wallet account data, and the like.

Communications network 100 may include one or more financial institution domains 102 interfacing with a bank, credit union, or other financial account service site that may provide banking services to user 122 as a client. Domain 102 is a financial institution that may issue a financial transaction device to user 122 based on client status and account information. Financial institution 102 broadly represents entities that may be considered financial institutions with services used by user 122. Financial institution 102 includes a server 110 supported by back bone 101. Server 110 hosts a software (SW) application 112 adapted to provide an electronic interface as a tool to user 122 for account use and management. SW 112 may include at least one component adapted to to cooperate over a network with SW 115 running on server 113 in cloud network domain 104.

Communications network 100 may include at least one network-based retailer selling products or services referenced herein by a server 107 supported by backbone 101, a software (SW) application 109 executing on server 107, and a data repository 108 coupled to server 107. Server 107 may represent any entity accessible to the user where a transaction may be performed. Data repository 108 may hold service and product related data, and user interaction and any transaction history user 122 has at the site.

Access to communications network backbone 101, which may represent the internet in one embodiment, may be through an Internet service provider (ISP)/access Gateway 106 supported by backbone 101. A carrier network 103 is depicted that enables communications including wireless communications to be bridged onto communications network 100 through ISP Gateway 106. Carrier network may be a wireless 5G network or similar mobile network that user 122 may use to access the network and practice local and long-distance communications using the representative mobile telephone. Mobile telephone 122 may be Bluetooth™ enabled by hardware and software (SW) 121 labeled BT. Telephone 122 may host a software (SW) application 120 adapted as a thin mobile SW application including a network connection and browsing ability that may locally display information screens like screen 119 in display on telephone 122.

User 122 is at a business domain 116 that may be a service, restaurant, retail establishment, parks service, or any venue that user 122 may enter to buy a product or service. In this embodiment, business 116 includes a point of sale (POS) machine or terminal 117 that takes, at least, credit and debit cards for satisfying financial transactions made by user 122. In this embodiment, user 122 has a dynamic universal transaction card 118 that may be electronically associated to a funding source account and may be accepted by terminal 117 to pay for goods or services. In a preferred embodiment, user 122 may transmit account data to card 118 from the mobile telephone while running SW 120 and SW 121 wherein the card 118 is Bluetooth™ enabled to at least receive the account data (card number) wherein the account data represents an account that user 122 has represented in a cloud wallet service provided by a wallet service using cloud network 104 to serve users and manage data.

User 122 may have several different accounts represented in cloud network 104 and dynamic transaction card 118 may be loaded with any of the user's account data to use that account to pay for goods or services during a transaction. SW 120 on mobile phone 122 enables the user to interact with cloud network 104 just before using card 118 at POS terminal 117 so that the user may determine which of several accounts might be imprinted to card 118 for use as a device representing that account. Application screen 119 on mobile phone 122 may be part of the interactive interface available to the user to load card 118 with the card number, security code, and other pertinent data so the card may be used as a card of the selected account. Any new account data that the user loads onto card 118 may or may not overwrite any previous account data on the card memory.

In a preferred embodiment, SW 115 executing on server 113 in cloud network 104 is adapted to record user preferences and notes relative to the user selecting an account to use (download to card) to pay for one or more transactions card 118 may be used for while representing a particular account. For example, the user operating mobile phone 122 may provide input at screen 119 or other input means while application 120 is running indicating that a particular transaction pending or in process may be a tax deductible or partially tax-deductible expense.

In one embodiment, the user may flag any transaction initiated and completed with card 118 for tax purposes where flagging the transaction may occur just before or just after using card 118. In this case the transaction number and details of the transaction may be communicated to the user operated mobile phone 122 before the card 118 is used to complete the transaction or just after the transaction is completed and approved where the POS is enabled to communicate such information by way of wireless communication to mobile phone 122.

In a case where POS 117 is not able to communicate to mobile phone 122, card 118 may communicate via Bluetooth™ to phone 122 that the transaction has been completed enabling the user to flag the transaction as a tax deductible transaction using SW 120 and interface screen interface 119. For example, the amount of the transaction, the time of the transaction, the location (terminal) of the transaction, the account funding the transaction is all available information to the smart card 118. This data may be communicated to mobile phone running SW 120 and interface 119 via wireless technology. In one embodiment, paper receipts including the card data may be scanned into mobile phone 122 by the user at the time of the transaction enabling the user to identify the tax deductible portion of the transaction for reporting to the cloud network 104 and or to financial institution 102 for record keeping purposes.

In a preferred embodiment, records of tax detectable transactions made with transaction device 118 are retrievable from cloud network 104 and/or from financial institutions like institution 102 over communications network 100 from a home network 105 using a connected computing device 123, in this case a laptop computer executing a software (SW) application 124 providing a screen based input enabled interface 125. For example, a user operating phone 122 may transact with card 118 flagging those transactions that the user may deem tax deductible wherein the records of those transactions are later retrievable by a certified public accountant (CPA) through accounting software, or a tax preparer through tax software, or the user executing software (124) available on Laptop 123, the records available from account activity history. This enables the user or an agent or service working on behalf of the user to retrieve all the tax-deductible transactions from all the account histories of the accounts that funded those transactions over a tax year in and can provide records in a format recognizable to well known tax preparation software.

In a simplistic embodiment, consider that card 118 is a dedicated bank card and that financial institution 102 is the issuer of that card. POS 117 may provide a bill and receipt that may be communicated to mobile phone 122 or may be scanned from screen by mobile phone 122 at which time the user may flag that transaction. In this case, the financial institution 102 may be notified by mobile phone 122 executing SW 120 wherein the server 110 executing SW 112 takes the flag and transaction details from the user and flags the transaction history on the account. Later, the user may operate laptop computer 123 on home network 105 executing SW 124 to retrieve all of the flagged transactions including transaction date, time, amount, number, location, business identification, and description (to line item granularity) of services or goods purchased.

In one embodiment, user 122 may use phone 122 as the transaction device rather than dynamic or dedicated transaction card. In another embodiment, another form of transaction device like a ring or a watch might be used in place of a card. In an embodiment where a transaction is conducted on a website and the transaction interface simply requires a typed in card data representing a dedicated account, notifications may be sent to the user post transaction offering the user a chance to flag the last transaction associated with that card data or a portion thereof as a tax deductible expense. If the website offers use of virtual cards from a cloud-based wallet account, a pop-up message may appear during the transaction offering the user a chance to flag the transaction or a portion thereof.

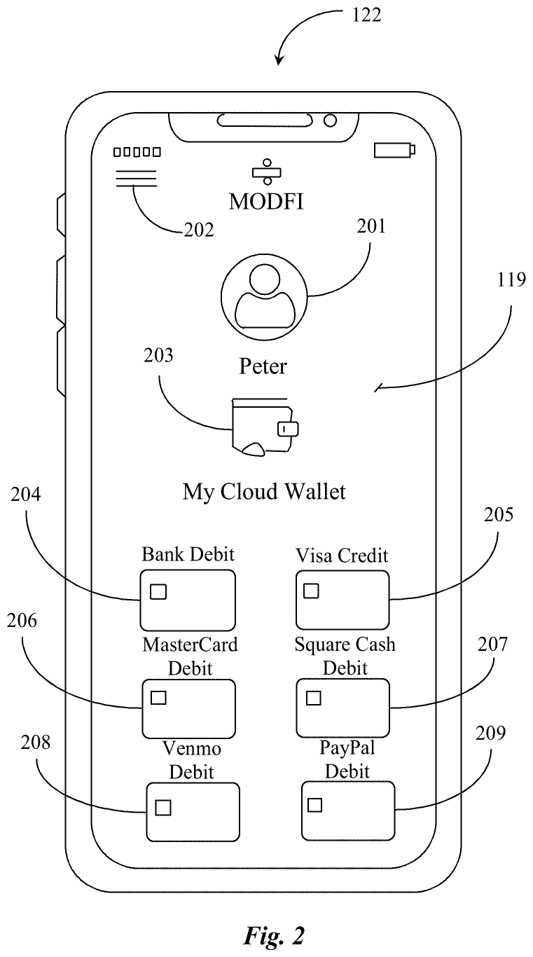

FIG. 2 is a screen shot of the mobile application 120 on phone 122 of FIG. 1 supporting transaction flagging at the point of sale terminal (POS) of FIG. 1. Mobile phone 122 has in display screen shot 119 depicting a cloud wallet account held by the user. In this embodiment the account is a Modfi cloud wallet account known to the inventor and subscribed to by the user. However, any cloud wallet account may be easily modified to practice transaction flagging without departing from the spirit and scope of the invention.

Interface screen 119 includes a menu 202 of a variety of options that a user may invoke while using the application. The application is personalized to the user 201 and provides access to account data for all of the accounts that user 201 (Peter) has uploaded the information for in order to include the accounts as possible payment accounts that may be selected to fund initiated transactions. An icon 203 represents a folder or “wallet” listing all the user accounts added to the service. Expanding wallet 203 may display several accounts separately for browsing, updating, or selection for a transaction. In this embodiment, accounts 204 through 209 are listed where 204 is a bank issued debit card account, 205 is a Visa issued credit card account, 206 is a MasterCard debit card account, 207 is a Square Cash debit card account, 208 is a Venmo debit card account, and 209 is a PayPal debit account.

User 201 may have in possession a dynamic transaction device like transaction card 118 of FIG. 1 and may using interface 119, select any one of accounts 204 through 209 to be assigned to the transaction device to use that account to fund any transaction as well as other tasks like using the dynamic card loaded with any of the account data sets to access the account through an ATM terminal for example. In this embodiment, a user may select any one of accounts 204 through 209 and load that account data set onto the transaction device, for example, card 118 of FIG. 1 to perform a transaction with the card having the funds for the transaction deducted from the selected account.

The function of loading a dynamic card with selected account data overwrites the existing account data on the card. A user may make more than one transaction with the transaction device loaded with a selected account and may overwrite the transaction device with any new account data (swapping accounts) making the next transaction associated with the next payment account data downloaded to the card. Using a transaction card with a writeable memory is not required to practice the invention. A dedicated transaction device may be used provided the account on the card is represented in the client application and the electronic transaction record the card will be used to satisfy is accessible to the client application.

In one embodiment, transaction flagging for tax purpose is a dynamic process occurring once at the relative moment in time of each transaction made. In one embodiment, the user may select the account desired for funding a next transaction and may flag that pending transaction upon evidence thereof by the POS terminal or interface (controls not illustrated) as a tax deductible event using interface 119 (applicable screen shot) produced by executing SW 120 of FIG. 1 and navigating the application interface.

In one embodiment, the user may click on any one of the listed accounts and mobile phone 122 may transmit an account data set to the dynamic card (118), and may flag the pending transaction as a tax deductible transaction in that process before the transaction is approved but generally after the transaction data (transaction number, date, time, amount, etc.) has been compiled at the POS terminal. The user may typically have a copy of the bill digitally available to mobile phone 122 either by transmission thereto or by optically scanning the bill that documents the transaction details before the card is inserted or otherwise used. This information may be propagated from the user's mobile phone or device 122 over the communications network to the cloud network to be associated with the actual transaction event (card insert/swipe).

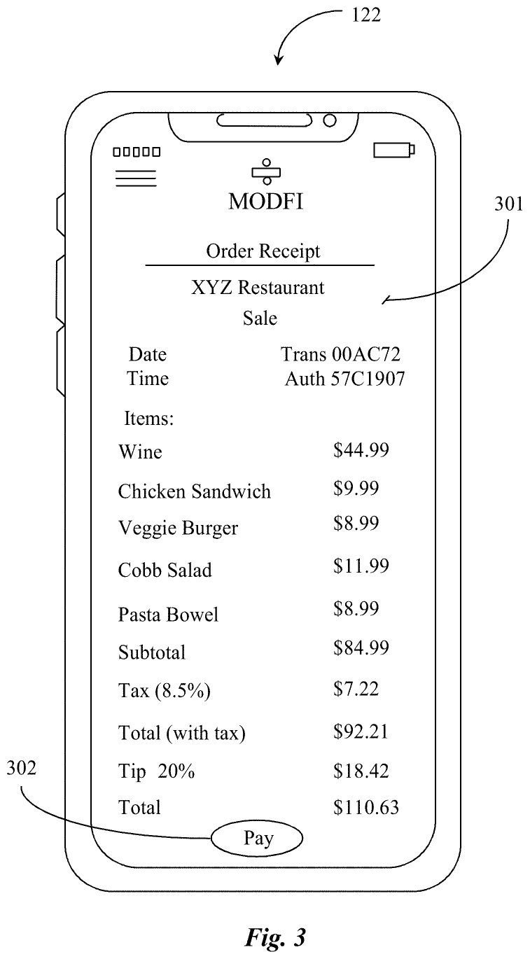

FIG. 3 is a screen shot 301 of the mobile application interface of FIG. 2 adapted for displaying paying an itemized bill. In this embodiment, the user operating mobile phone 122 can receive via wireless communications an electronic bill from a POS terminal and display the information in screen shot 301 as a pending transaction. In this embodiment, the information displays as an order receipt with a date, time, a transaction number, and an authorization event number where the last two numbers are previously generated at the POS before taking actual payment and become the transaction event numbers once the transaction is completed. Restaurant

In this embodiment, the order receipt or bill identifies the merchant and lists the items and item pricing as well as the tax percentage and total with tax, a server tip percentage and grand total for the transaction. The electronic bill includes a pay button 302 the user may invoke to pay the total. In one embodiment, each line item may be selectable if the bill is a shared bill and the user is paying only a portion of the bill. In such a case, the tax and tip may be automatically calculated from the selected line items for the user and a new rendition having the same numbers may be displayed with pay button 302 available at the bottom.

It may be that the bill is a business expense paid for by the user during a working business trip where all or a portion is a deductible business expense. The user selecting pay bill may call up the user's cloud wallet listing several accounts that the user may choose from to complete the transaction.

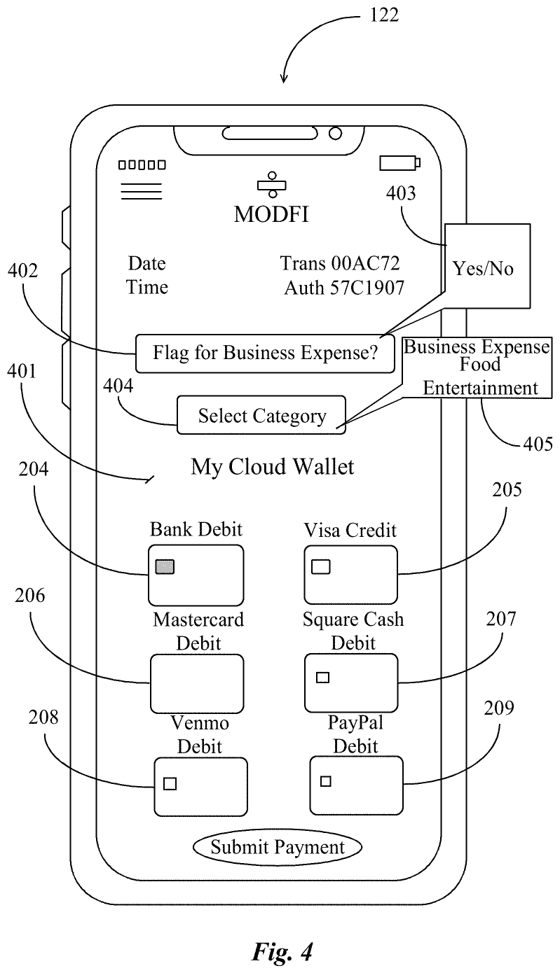

FIG. 4 is a screen shot 401 of the mobile application interface of FIG. 2 adapted for flagging a transaction in process and for selecting the funding source or sources. Screen shot 401 may be called up when the user operating mobile phone 122 decides to select pay using pay button 301 of FIG. 3 above. In this embodiment, accounts 204 through 209 are listed for the user and may be selected as a source of funding for the transaction identified on this screen by the date, time, transaction number, and authorization number. In this instance, the user has selected the bank-issued debit card account 204 to fund the transaction.

In one embodiment, an interactive flagging control 402 is displayed in or pops up as an interactive asking the user if the transaction should be flagged as a business expense for tax purpose. The user may select yes or no in dialog 403 to confirm status (deduction/non-deduction) for this transaction funded by the selected account 204. In one embodiment, an option 404 for selecting a category from a list of categories may be provided or pop up as an interactive if the user has confirmed yes, the transaction should be flagged in dialog 403. The user may select category and confirm in dialog box 405, in this case business expense: food, and entertainment.

In one embodiment, the application has the intelligence and information required to automatically assign the just flagged transaction to a correct category based on the information about the transaction without user input. The user may override such a feature if desired. After account selection and flagging for deduction, the user may submit the payment into record. The tax status of the transaction record may accompany the transaction record to the transaction historical archives in the cloud network storage for the account the user selected to fund the transaction.

In one embodiment, the tax status flag data may be communicated from the mobile telephone 122 over BT to the dynamic transaction device analogous to card 118 of FIG. 1 and may be read by a financial institution analogous to institution 102 of FIG. 1 operating server 110 aided by SW 112 and storing updated account data for the user in repository 111 of FIG. 1. In this way the original issuer of the bank debit card has the data at the time of debit to the account by the merchant for the transaction amount and the tax flag for that transaction becomes a part of the account activity archives at the bank for the user.

The user may, through a banking client application or through an online banking interface, browse the account activity data and see the tax deductible expenses archived over time in a way that may be categorized, totaled, sorted, and searched. In one embodiment, a user may configure a wallet account, for example, a travel card account, for automatic flagging of expenses debited that travel account, but may override any transactions that are not tax deductible such as vacation travel paid for from the same account.

In one embodiment of the present invention, the cloud network analogous to network 104 of FIG. 1 aided by server 113 executing SW 115 may also incorporate tax analysis to weigh user flagged items in account histories with current tax laws and allowance rules and may periodically notify the user of issues that might arise because of a flag or benefits that might be possible if transactions that could have been flagged were somehow overlooked. A feature such as this could be implemented in SW 115 and could be executed on account transaction history periodically and may report to the user any findings.

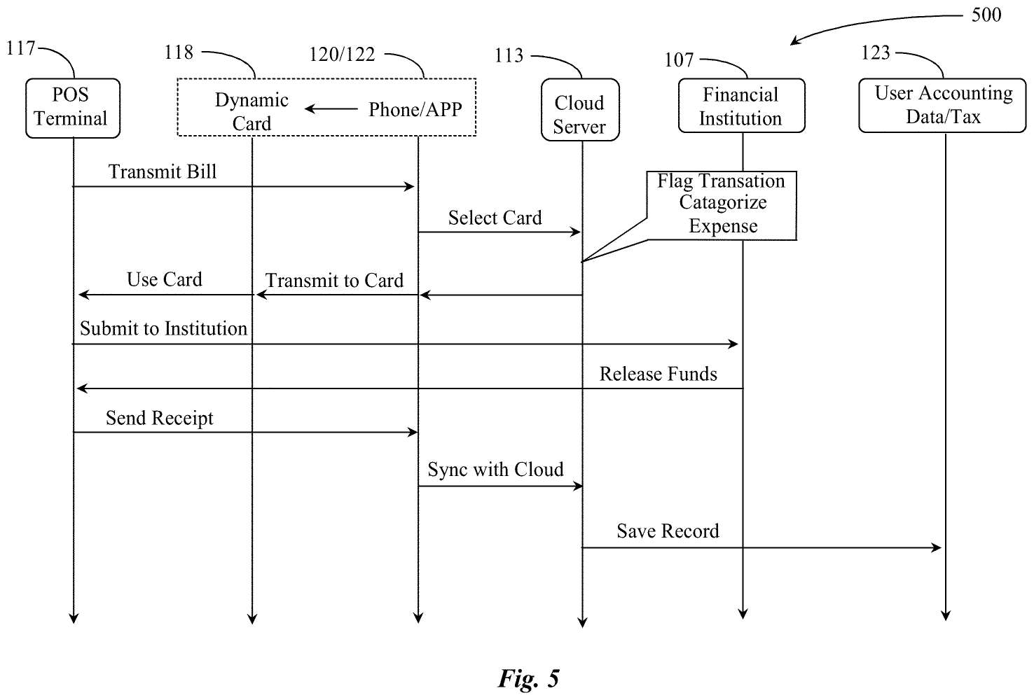

FIG. 5 is a sequence diagram 500 depicting a transaction flagging sequence according to one embodiment of the invention. In one embodiment, a user is interacting with a point of sale terminal like POS 117 using a dynamic card like card 118 using a mobile phone like phone 122 and a cloud wallet application or money application like SW 120 as depicted in the embodiment of FIG. 1. In process, the POS 117 may send or otherwise transmit a bill/receipt for goods and/or services to the user operating mobile phone 122 aided by SW 120.

The user operating phone 122 aided by SW 120 may connect to cloud server 113 analogous to server 113 of cloud network 104 of FIG. 1 for the purpose of selecting a card account to debit for the pending transaction, the transaction data sent along with the request. The user may use the controls provided after account selection to flag the transaction event as a potentially tax-deductible expense including providing any Meta data about the category of the expense, for example business meal or office supplies, etc. In one embodiment, the server automatically categorizes the deductible transaction using the information about the transaction and other intelligence such as location of the user, calendar time of the transaction, etc. In one embodiment, the service may prompt a user after a transaction has not been flagged if the system thinks the transaction might be a deductible expense based on known information.

The cloud server transmits at least the account data set required to authorize and complete the transaction to the user's mobile phone and the phone transmits the data to card 118, which is this case is the transaction device. The transaction device could be a mobile wallet or, another device or the mobile telephone without departing from the spirit and scope of the present invention. The card may then be used at the POS terminal 117 to complete the transaction. At a point during or after the completion of the transaction, POS terminal 117 submits the transaction authorization to the financial institution or commercial source of the funding and account to debit the funds. This may occur in real time or post completion of the transaction depending in part on the nature of the account and activity.

The account source or financial institution 107 may then release the funds to cover the transaction. A receipt may be printed and handed to the user or may be electronically sent to the user at phone 122. In one embodiment, the user operating phone 122 may sync with cloud 113 to update the status of the account at the cloud server 113. The cloud server may update account balance and already is aware of the tax status of the transaction. In an embodiment where the financial institution 107 is aided by SW to practice the invention, Meta data marking a transaction as a deductible expense may be transmitted to the card and read with the card data when the POS submits the data to the institution for approval of the transaction. However, in one embodiment, cloud server 113 keeps a transaction history for the accounts used with dynamic transaction device 118.

In the embodiment where cloud server 113 creates an account activity historical archive for every account listed, the data may be accessible through or pushed to a user operated computing device 123 analogous to laptop 123 of FIG. 1 executing accounting, investment, or tax software analogous to SW 124 and screen shot 125 of FIG. 1. In an embodiment where the status for a transaction is provided to the dynamic card along with the required account data set to activate the card for payment, the financial institution 107 may append the tax status data to the transactional activity of the account. In such an embodiment, computing device 123 may access that data from the financial institution using computing device 123 and account, investment, or tax software being used locally, or through a web banking interface provided by the institution for customers.

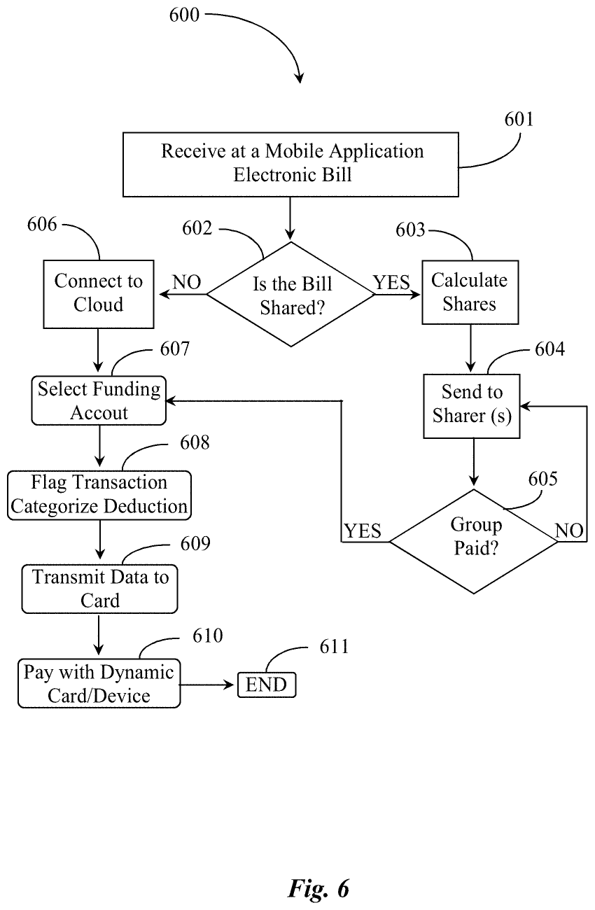

FIG. 6 is a process flow chart 600 depicting steps for applying a tax deduction status to an expenditure transacted at a POS terminal. At step 601, a user operating a mobile payment application may receive an electronic bill. Typically, the bill may represent a transaction event including merchant identification, date, time, transaction number, and the document may include line items and line item pricing, and accounting revealing totals and tax and tip information.

At step 602, a determination may be made if the bill is a shared bill meaning more than one account will be debited to pay the bill, or if the bill is not a shared bill. At step 602 if the bill is a shared bill, the pay application operating locally on the user's device may calculate the shares owed from the bill at step 603. This calculation may be based at least in part on order information known to or input into the user's payment application. This thread assumes the user will cover the transaction but also receive any money owed to the user from another user or users via their payment applications. At step 604, the user application may send to another user or users' devices copies of the bill calculating the amounts they owe.

At step 605, the user may determine if the other user or users sharing the bill have paid their portions to the bill paying user's designated account. If at step 605, one or all has not paid, the process may loop back to step 604. If the determination at step 605 is that the other user of group thereof has paid, then the covering user may select a funding account 607 through which the transaction may be covered. In this step it is assumed that the user is connected to the cloud wallet account. At step 602, if the bill was not a shared bill, the process moves to step 606 where the user may connect to cloud network services through the resident application.

At step 607 the user may select an account listed in the cloud service to satisfy the transaction with. At step 608, the user may input transaction deduction status if any and to provide characterizing data relative to the nature of the event. At step 609, the user operating the mobile phone may transmit the selected card account data to the dynamic card and may further incorporate tax status information for flag data relative to the identified transactions to the card. At step 610, the user may insert, swipe, or otherwise use the transaction device, in this case a dynamic card, to complete a transaction (make a payment). At step 611, the process may end for that user.

In one embodiment of the invention, the user may only be paying for a part of a group bill. However, the portion of the total that the user is responsible for may be treated as a single user bill by the user's SW application and can be flagged through the application as a tax deduction. In another embodiment, only specific line items of a bill are tax deductible items whereas certain other items on the same bill are not tax deductible. In such a case, a user may select an item or items listed and flag those items as tax deductible, for example, if office supplies are purchased along with regular groceries. The accounting data for that event may show the total amount of the bill and the amount attributed to deduction, or the price of the office supply items.

It will be apparent with skill in the art that the transaction flagging method of the present invention may be provided using some or all the elements described herein. The arrangement of elements and functionality thereof relative to the flagging system of the invention is described in different embodiments each of which is an implementation of the present invention. While the uses and methods are described in enabling detail herein, it is to be noted that many alterations could be made in the details of the construction and the arrangement of the elements without departing from the spirit and scope of this invention. The present invention is limited only by the breadth of the claims below.

1. A method for electronic flagging an electronic transaction amount or a portion thereof as a potential tax-deductible expense, the transaction initiated at a point of sale (POS) terminal or interface connected to a communications network comprising the steps:
(a) receiving or otherwise acquiring an electronic transaction record at a mobile hand-held phone, the computing device having network-access capability and connected to the communications network, the record generated at the POS terminal or interface, the record displayed in a dedicated payment application executed on the computing device;
(b) assigning to a transaction card via the dedicated payment application a payment account, selected from a plurality of payment accounts to pay the transaction amount or portion thereof electronically using the transaction card dynamically associated with the assigned payment account; and
(c) selecting an interactive icon presented in the dedicated payment application, after assigning the payment account, asking if the record should be flagged as a tax deductible expense, the input response requesting to flag the transaction amount or portion thereof as a tax deductible expense.

2. The method of claim 1, wherein the communications network includes the Internet network and any connected access and payment networks.

3. The method of claim 1, wherein in step (a) the payment application is a resident client application of a cloud-based wallet account storing authorized payment data including account, card number and account type the plurality of payment accounts.

4. The method of claim 1, wherein in step (a) the transaction record includes a transaction date, a transaction time, a merchant identification, a POS location, and a transaction number and wherein the transaction record is transmitted wirelessly or by carrier network from the POS to the mobile phone;

5. The method of claim 1, wherein in step (a) the transaction record includes a transaction date, a transaction time, a merchant identification, a POS location, and a transaction number and wherein the transaction record is printed and scanned into the mobile phone using an optical scanning feature.

6. The method of claim 1, wherein in step (b) the payment accounts are presented in a list for selection via interactive icons.

7. The method of claim 1, wherein in step (c) the method of input is touch screen selection, response to a notification message, or a voice confirmation of yes or no.

8. The method of claim 1, wherein in step (c) a further sub step is provided for assigning a specific tax category selected from a plurality of tax categories for the flagged transaction amount or portion thereof.

9. The method of claim 1 further including a step (d) for recording the flagged electronic transaction record in a data repository coupled to the dedicated payment application records for the account selected to pay the transaction amount or portion thereof.

10. The method of claim 1, wherein in the transaction amount or portion thereof is paid electronically using the transaction card having a rewritable memory thereon.

11-12. (canceled)

13. The method of claim 1 wherein in the step of assigning a payment account, data indicating the payment account is transmitted to the transaction card wirelessly from the dedicated payment application on the mobile phone.

14. The method of claim 1, wherein more than one payment account may be assigned to the transaction card and used to pay the amount of the electronic transaction.
